(19) United States
(12) Patent Application Publication
(10) Pub. No.: US 2010/0009048 A1
(43) Pub. Date: Jan. 14, 2010

(54) PROCESS FOR IMPROVING WATER HOLDING CAPACITY AND TENDERNESS IN COOKED PROTEIN FOOD PRODUCTS

(75) Inventors: Herbert O. Hultin, Rockport, MA (US); Shuming Ke, Edmonton (CA); Yan Huang, Kendall Park, NJ (US); Sinan Imer, Bakersfield, CA (US); Patroklos Vareltzis, Thessaloniki (GR)

Correspondence Address: FISH & RICHARDSON PC, P.O. BOX 1022, MINNEAPOLIS, MN, 55440-1022, US

(73) Assignee: UNIVERSITY OF MASSACHUSETTS, Boston, MA (US)

(21) Appl. No.: 12/093,900

(22) PCT Filed: Nov. 16, 2006
(86) PCT No.: PCT/US2006/044453

§ 371 Date: Mar. 3, 2009

Related U.S. Application Data
(60) Provisional application No. 60/737,144, filed on Nov. 16, 2005.

(51) Int. Cl. A23L 1/31; A23L 1/325; A23L 1/315; A23L 1/318; A23B 4/28

(52) U.S. Cl. 426/281; 426/442; 426/656; 426/657; 426/641; 426/643; 426/644; 426/647

(57) ABSTRACT

Processes for processing food products by adjusting the pH of the food product from a first pH to a second pH and then to a third pH, with or without cooking, are provided. Also provided are methods for adjusting the pH of a food product using buffers.

### CROSS-REFERENCE TO RELATED APPLICATIONS

This application claims the benefit of the filing date of U.S. Provisional Application No. 60/737,144, which was filed on Nov. 16, 2005. The contents of U.S. Application No. 60/737,144 are incorporated by reference as part of this application.

### STATEMENT AS TO FEDERALLY SPONSORED RESEARCH

This invention was made with Government support under grant # 2004-02390, awarded by the USDA NRI. The Government has certain rights in the invention.

### TECHNICAL FIELD

This invention relates to food processing, and more particularly to processing of muscle tissue.

### BACKGROUND

Food products containing proteins (e.g., muscle food products such as meat) are often cooked (e.g., completely cooked or partially cooked) and then stored prior to consumption. A recent article in Meat Marketing & Technology (P. Hinsey, “Warmed over and out,” Oct. 2005, 85-89) points out the advantages of pre-cooking meat for the retail and institutional markets. Cooking in large quantities is efficient and produces consistent quality, allowing for good quality control. Food safety programs are easier to implement and control in centralized facilities than in the field. Starting with a cooked product saves time, labor, and equipment costs in restaurants and food service establishments and reduces chances of employee injury. However, pre-cooking meat can have several disadvantages. The pre-cooked meat can have a tendency to be tough and/or dry (as compared with freshly-cooked meat) and to exhibit a “warmed over flavor” (WOF) due to oxidation of lipids in the meat.

### SUMMARY

The invention is based, in part, on the discovery that water-holding capacity and/or tenderness of protein food products can be increased by at least partially solubilizing and/or dissociating proteins in a muscle food product (e.g., by adding an acid or base to the protein food product to change the pH) and that this increase can be maintained upon readjusting the pH (e.g., to its original pH or to a pH closer to neutral than the changed pH). For example, the proteins (e.g., cytoskeletal and/or myofibrillar proteins) are solubilized and/or dissociated in whole or in part either by acid or alkaline treatment and can be heated (e.g., cooked) in this form, which results in an increase in the water binding capacity and tenderness as compared with a food product not subjected to an acid or alkaline treatment. Without intending to be bound by theory, it is believed that this is the result of the expansion of the cellular structures, and resultant increase in water absorbability, that is allowed by the solubilization and/or dissociation of the proteins. These increases are surprisingly retained upon readjusting the pH. The water-holding capacity and/or tenderness of the protein food product can be further enhanced by the adding of texture-improving ingredients such as, for example, muscle proteins or muscle protein isolates.

Adjusting the pH of the food product can be carried out in any way known to those skilled in the art. For example, the pH can be first decreased (e.g., by adding an acid) and then increased (e.g., by adding a base), or first increased and then decreased. These double pH adjustments can be both carried out before cooking the food product. Alternatively, it may be useful to perform the first pH adjustment, heat the food product, and then perform the second pH adjustment. Adjusting the pH can also be carried out by injecting a food product, e.g., a muscle food product, with a protein isolate described herein without a second re-adjustment of the pH.

In one aspect, methods of preparing a food product are featured. The methods include obtaining a food product including at least one of a myofibrillar and a cytoskeletal protein and having a first pH; adjusting the pH of the food product to a second pH that at least partially disorganizes at least a portion of the structure of the food product (e.g., protein, e.g., muscle protein, within the food product); and heating the food product to a temperature above the denaturation temperature of the protein.

Embodiments can include one or more of the following features.

The methods described herein can optionally include the step of heating the food product. The first pH of the food product can be adjusted to a second pH by combining the food product with a pH-adjusting solution. The second pH can be lower than the first pH. The second pH can be, e.g., no more than about 5.5, e.g., no more than about 4.0. The second pH can be higher than the first pH. The second pH can be no less than about 6.7, e.g., no less than about 7.5, 8, 9, 10.5, or 12.5. For example, the second pH can be about 5.5, 4.0, 4.5, 4.0, 3.5, 3.0, or lower than 3.0, if desired. For example, the second pH can be about 6.7, 7.5, 8.0, 8.5, 9.0, 9.5, 10.0, 10.5, 11.0. 11.5, 12.0, 12.5, or higher than 12.5 if desired.

The pH of the food product can be readjusted to a third pH. The third pH can be lower than the second pH The third pH can be higher than the second pH. The third pH can be approximately equal to the first pH. The third pH can be higher than the first pH. The third pH can be about 7.0.

The pH-adjusting solution can include an acid, e.g., a weak acid (e.g., an organic acid, e.g., citric acid, malic acid, lactic acid, malonic acid, and/or succinic acid), a strong acid (e.g., hydrochloric acid, sulfuric acid, sodium bisulfate), an organic acid, an inorganic acid, phosphoric acid, hydrochloric acid, suliric acid, sodium bisulfate, and amino acids, e.g., glycine, cysteine, hydrolyzed protein(s). The pH-adjusting solution can comprise a base, e.g., sodium carbonate, sodium bicarbonate, or amino acids, e.g., glycine, cysteine, hydrolyzed protein(s).

The pH-adjusting solution can comprise a buffer having a pKa above the second pH. The pKa of the buffer can be within one pH unit of the second pH. The pH of the buffer can be about one pH unit above its pKa (for a basic buffer) or about one pH unit below its pKa (for an acidic buffer). The pH of the food product can be adjusted to a second pH by adding more base and increasing the buffer concentration. The buffer can comprise amino acids, e.g., glycine, cysteine, hydrolyzed protein(s), phosphate, polyphosphate, sodium acid pyrophosphate, sodium tripolyphosphate, bicarbonate.

One or more texture-improving components can be added to the food product (e.g., by including the component(s) in a pH-adjusting solution), e.g., a protein isolate, calcium chloride, sodium chloride, and potassium salt. The protein isolate can be prepared from one of: muscle tissue, soy protein, or wheat protein. The protein isolate can be prepared from the same animal species as the food product.

Other water holding agents (e.g., proteins and/or polysaccharides) can be added to improve texture and water holding capacity of the food product. Soluble or insoluble proteins can be injected. A protein isolate can be prepared at either acid or alkaline pH, e.g., using various buffers described herein, and injected primarily as an insoluble protein. Acidic soluble proteins can be injected into muscle food products that have been adjusted to a low pH. It may be useful to inject water holding agents, e.g., proteins, obtained from one animal species into a food product, e.g., meat, from the same species.

Added agents, e.g., protein isolates, can play a role in controlling the viscosity of the food product. Alternatively or in addition, viscosity can be controlled by, e.g., adjusting salt concentration, protein concentration, and pH. A higher viscosity of the protein isolates themselves can be achieved, e.g., by raising the pH to a high value and then lowering it to a desired value. For example, a relatively higher viscosity can be achieved when the protein isolate is exposed to pH 10 and then brought back to pH 9, than would be achieved if the isolate were adjusted to pH 9 directly. The viscosity of the protein isolates can be controlled by adjusting salt concentration and/or protein concentration, in addition to pH.

Adjusting the pH of the food product and/or adding protein agents can be carried out using specific injection techniques. Exemplary useful injection methods are disclosed herein.

The food product can be meat, e.g., fish, shellfish, squid, poultry, beef, lamb, and pork. The food product can optionally be heated to a temperature of at least about 45° C., at least about 50° C., at least about 70° C., or at least about 80° C. The food product can be combined with a pH-adjusting solution using a step such as: injecting the pH-adjusting solution into the food product, tumbling the food product in the pH-adjusting solution, and/or soaking the food product in the pH-adjusting solution. Any combination of these three steps can be used. The food product can be processed, e.g., diced or minced prior to combining the food product with the pH-adjusting solution.

In another aspect, methods of preparing a food product are featured. The methods include obtaining a food product including at least one of a myofibrillar and a cytoskeletal protein and having a first pH; adjusting the pH of the food product to a second pH more basic than the first pH that at least partially disorganizes at least a portion of the structure of the food product (e.g., protein, e.g., muscle protein, within the food product); and heating the food product to a temperature above the denaturation temperature of the protein.

Embodiments can include one or more of the following features.

The methods described herein can optionally include the step of heating the food product. Between the steps of (i) adjusting the pH of the food product to a second pH and (ii) heating the food product, a step of readjusting the pH of the food product to a third pH can be carried out.

The second pH can be selected from the group consisting of no less than about 6.7, e.g., no less than about 8, 9, 10.5, or 12.5. For example, the second pH can be about 6.7, 7.0, 7.5, 8.0, 8.5, 9.0, 9.5, 10, 10.5, 11.0, 11.5, 12.0, 12.5, or higher than 12.5 if desired.

In another aspect, methods of preparing a food product are featured. The methods include obtaining a food product having a first pH and including at least one of a myofibrillar and a cytoskeletal protein; and combining the food product with a phosphate solution to raise the pH of the food product to a second pH, wherein the phosphate solution has a pKa greater than the second pH.

Embodiments can include one or more of the following features.

The phosphate solution can have a pKa greater than the second pH. The pKa of the phosphate solution can be about 1 pH unit greater than the second pH. The phosphate solution can have a pH of about one pH unit above its pKa. Raising pH of the food product can include adding a base and increasing the phosphate solution concentration. The phosphate solution can comprise, e.g., a polyphosphate, sodium acid pyrophosphate, sodium tripolyphosphate, or sodium hexametaphosphate.

In another aspect, methods of preparing a food product are featured. The methods include obtaining a food product having a first pH and including at least one of a myofibrillar and a cytoskeletal protein; and combining the food product with a buffer solution to adjust the pH of the food product to a second pH.

Embodiments can include one or more of the following features.

A base that has a pKa value of no less than the second pH can be added to the buffer solution. An acid that has a pKa value of no more than the second pH can be added to the buffer solution. The buffer solution can comprise, e.g., a phosphate, a polyphosphate, sodium acid pyrophosphate, sodium tripolyphosphate, or sodium hexametaphosphate. The buffer solution can have a pH of about one pH unit above its pKa (for an basic buffer) or about one pH unit below its pKa (for an acidic buffer).

In another aspect, methods of preparing a food product are featured. The methods include obtaining a food product including at least one of a myofibrillar and a cytoskeletal protein and having a first pH; adjusting the pH of the food product to a second pH that at least partially disorganizes at least a portion of the structure of the food product (e.g., protein, e.g., muscle protein, within the food product) by injecting the food product with a protein isolate, e.g., a protein isolate described herein.

Embodiments can include one or more of the following features. The protein isolate can include a pH-adjusting solution. The second pH can be higher than the first pH. The food product can be further heated to a temperature above the denaturation temperature of the protein.

Food products prepared using the methods provided herein can have improved water-holding capacity, tenderness, decreased toughness, improved flavor, improved texture, and/or improved storability as compared with food products not subject to methods described herein.

In some embodiments, the pH can be adjusted using phosphate buffers having a lower concentration of phosphates than is possible using known methods.

Unless otherwise defined, all technical and scientific terms used herein have the same meaning as commonly understood by one of ordinary skill in the art to which this invention belongs. Although methods and materials similar or equivalent to those described herein can be used in the practice or testing of the present invention, suitable methods and materials are described below. All publications, patent applications, patents, and other references mentioned herein are incorporated by reference in their entirety. In case of conflict, the present specification, including definitions, will control. In addition, the materials, methods, and examples are illustrative only and not intended to be limiting.

Other features and advantages of the invention will be apparent from the following detailed description, and from the claims.

### DETAILED DESCRIPTION

A food product, e.g., a protein food product including myofibrillar and/or cytoskeletal protein, can be treated to adjust the pH of the food product from a first pH to a second pH (e.g., a more acidic or more basic pH) such that at least some of the structure of the food product (e.g., muscle protein) is disorganized, e.g., at least some (e.g., substantially all) of the myofibrillar and/or cytoskeletal protein is at least partially solubilized and/or dissociated, resulting in an increase in the ability of the food product to take up water, which can improve the texture and water-holding capacity of the food product. The food product can then optionally be heated to a temperature above the denaturation temperature of the proteins, and the pH of the food product can optionally be readjusted to a third pH (e.g., a pH approximately equal to the first pH), e.g., before or after heating. pH adjustment (single or double) can also be carried out with or without heating. The pH of the food product can be adjusted by combining the food product with a pH-adjusting solution that can comprise various acids, bases, and/or buffers described herein. The water-holding capacity and/or tenderness of the food product can be further enhanced by the addition of texture-improving ingredients, e.g., muscle proteins and/or muscle protein isolates. Methods described herein can be used on, e.g., any food product comprising proteins (e.g., animal proteins, e.g., derived from fish, shellfish, squid, poultry, beef, lamb and/or pork).

### Acid Process

### 1. Disorganizing the Structure of the Food Product

The tenderness and water-holding capacity (WHC) of muscle tissue food products (e.g., meat, poultry, pork, lamb, fish, shellfish, and squid) can be improved by first decreasing the pH (i.e., acidifying) of intact, minced, or washed minced muscle tissue with an acid. This process can change, e.g., disorganize, the structure of the food product, e.g., muscle protein. For example, the myosin, myofibrils, and/or Z-disc structures of a muscle food product can become altered or disorganized. Also, the myofibrillar and/or cytoskeletal proteins can be solubilized and/or disorganized. Such changes can allow for uptake of water and expansion of the tissue. Skilled practitioners will appreciate that disorganization of the structure of the food product can be observed, e.g., detected, measured and/or monitored, if desired, using any art-known methods, e.g., light microscopy or electron microscopy. Disorganization of particular proteins can if desired, also be detected with techniques known in the art, e.g., isolation of protein(s) and gel electrophoresis.

a. pH-Adjusting Solutions

Adjusting (i.e., lowering or raising) pH of the food product can be carried out by combining the food product with a variety of pH-adjusting solutions, e.g., solutions described herein and/or known in the art. For lowering the pH in the acid process, the solution can include a weak acid, e.g., organic acid, inorganic acid, and/or amino acids, e.g., glycine, cysteine, hydrolyzed protein(s). The organic acid can be, e.g., citric acid, malic acid, lactic acid, malonic acid, and/or succinic acid. Calcium chloride may improve the effects (e.g., antioxidative, water-holding capacity, or tenderness effects), of organic acids, especially citric acid. Organic acids can be useful because, e.g., they do not expose the muscle tissue to a very low pH, and in some applications can serve to control pH with their buffering capacity. The pH-adjusting solution can include strong acids, e.g., hydrochloric acid, sulfuric acid, or sodium bisulfate. For raising pH, the pH-adjusting solution can include sodium carbonate, sodium bicarbonate and/or amino acids, e.g., glycine, cysteine, hydrolyzed protein(s). The pH-adjusting solution can also include a phosphate solution, e.g., a polyphosphate, sodium tripolyphosphate, and/or sodium hexamethaphosphate.

The pH-adjusting solution can include various buffers that can serve as “storage depots” for an acid or a base. A buffer can absorb much base or acid around its pKa value without greatly changing pH of the solution. The buffer solution can be adjusted to a pH value that is about one pH unit higher (for a basic buffer) or about one pH unit lower (for an acidic buffer) than the pKa of the buffer. An acid or a base can then be added to the food product to adjust its pH. Such buffer solutions offer a number of advantages. First, the buffer can carry much more base or acid for adjusting the pH of the food product than it could normally if the buffer salt were simply used directly, thus maximizing the efficiency of the buffer. Thus, a greater change in pH of the targeted muscle food product can be achieved at a lower concentration of buffer. Second, the use of a buffer at a pH within one unit of its pKa can act as a “brake” and prevent rapid over-shooting of the target pH when an acid or a base is being added to the food product. Third, potential flavor problems caused by excess buffer can be reduced. Fourth, legal limits on buffer concentration can be met more easily. Such concerns can be important, for example, in the U.S. where phosphate buffers have a legal limit of 0.5%, calculated as P205. In Europe, phosphate is currently not an acceptable additive. Sodium carbonate and sodium bicarbonate are typically not subject to similar restrictions, but if too much of these compounds are added, carbon dioxide gas can be produced during cooking, resulting in a honeycomb appearance in the cooked muscle tissue. The use of sodium carbonate can produce good texture and flavor, and much less carbonate, on a molar basis, is required to achieve a particular pH change than bicarbonate, which can reduce the potential of carbon dioxide gas production.

An exemplary buffer that can be used in the present methods is glycine, whose acidic portion can act as an acidifying agent. For example, the pH of the glycine buffer can be lowered about one unit below its pKa, offering at least three potential advantages: (a) the buffer can accept much acid added for pH adjustment, maximizing the buffer's efficiency and reducing the need for adding more buffer; (b) the buffer can prevent drastic over-shooting of the target pH when the acid is being added; and (c) flavor is generally not affected by glycine.

The buffer can be phosphate, polyphosphate, sodium acid pyrophosphate, sodium, tripolyphosphate, bicarbonate and/or amino acids, e.g., glycine, cysteine, hydrolyzed protein(s). Glycine and most other amino acids do not contribute to the acidic taste of foods. In addition, glycine is soluble, has good taste, is inexpensive and has no asymmetric carbon (i.e., is not generally present in a D-amino acid form that is not nutritionally useful). Mixtures of amino acids or protein hydrolysates that include mixtures of amino acids can be used as buffers. Such mixtures can offer advantages similar to glycine. Cysteine can also be used as a buffer.

Skilled practitioners will appreciate that a wide variety of acid, base, and/or buffer variations and combinations in pH-adjusting solution are possible for use in the present methods, depending on application.

b. Methods of Adjusting pH

Adjusting pH, e.g., by acidification, can be accomplished using any method known in the art, e.g., by injecting a pH-adjusting solution, e.g., an acid solution into intact muscle tissue, soaking intact muscle tissue in a solution containing acid, and/or mixing an acid (e.g., an acid solution) with minced muscle. Useful injection techniques are described herein and/or are known in the art. A solution can be introduced to the food product through multiple small volume injections, which can result in incremental changes in the pH and can result in a more even distribution of the acid solution into the food product. Distribution of acid through the food product can be accomplished or aided by using a vacuum.

pH of the food product can be adjusted in several steps. For example, where a large pH change is sought, the total amount of adjusting solution (e.g., with or without buffer) required can be separated into multiple portions and injected sequentially in time, and the food product can be optionally tumbled and/or vacuum can be applied to aid in distributing that portion before adding the next portion. This can be useful, for example, where a stronger acid is used, or where a large quantity of acid is used, to prevent over-acidification of the area localized near the point of injection. The pH of the food product can in some instances be adjusted in as little as 20 minutes (e.g., about 15 minutes, about 10 minutes, or about 5 minutes).

Adjustments of pH of outer sections of the muscle tissue can be performed by tumbling in adjusting solution (e.g., in an amount of acidic solution that totals from about 10% by weight to about 20% by weight of the total food product used to adjust the pH). The solution can contain salts (e.g., sodium chloride (NaCl), potassium chloride (KCl), or calcium chloride (CaCl₂), other potassium salts, or mixtures thereof) to control protein solubilization and water uptake. The solution can have between about 25 to about 300 millinormal (mN) salt (e.g., about 50 mN salt, about 100 mN salt, 150 mN salt, about 200 mN salt).

In some instances, the pH of the food product can be lowered below 5.0, e.g., to about 3.5, about 4.0, or about 5.5. In some instances the pH can be lowered below 3.5.

### C. Titration

Food product can be titrated to determine the amount of acid, base and/or buffer to be added to the food product to achieve the desired pH. Generally, the food product is ground, optionally homogenized, and mixed with water, e.g., at a ratio of from about 5 parts to about 10 parts of water per part of food product. A titration is then performed by any known method, e.g., using a pH meter to determine pH and a burette to dispense acid, base, and/or buffer.

### 2. Heating the Food Product

The food product can optionally be heated (e.g., cooked or partially (“par”) cooked) to a temperature above the denaturation temperature of the protein in the food product. This can “set” the proteins in the partially solubilized and/or dissociated configuration, resulting in these proteins retaining this configuration, e.g., upon cooling and/or upon readjusting the pH of the food product. Any heating technique known in the art can be employed. In some instances, the food product can be heated at a relatively low temperature over a relatively long period of time. The temperature and time involved may vary, depending on the type of food product (e.g., a food product derived from fish, shellfish, squid, poultry, beef, lamb, or pork), the size or volume of food product to be heated, and the desired degree of completion of cooking.

For example, muscle tissue injected, soaked and/or tumbled in an acidic adjusting solution may be heated to “set” the proteins in their configurational and spatial arrangements. When treating food product derived from fish, for example, the food product can be heated to a temperature of at least about 45° C. (e.g., at least about 75° C.). As another example, where the food product is derived from beef, the food product can be heated to a temperature of at least about 50° C. (e.g., at least about 80° C.). Without intending to be bound by theory, the proteins set upon heating because, e.g., the thermal denaturation of the proteins that occurs on heating causes unfolding with exposure of various hydrophobic groups that allow the proteins to irreversibly aggregate in the cooked protein gel. Distribution of acid can be accelerated if muscle tissue is tumbled after injection, optionally under vacuum, before and/or after cooking.

### 3. Addition of Texture-Improving and Other Ingredients

Other water holding agents (e.g., proteins and/or polysaccharides) can be added to improve texture and water holding capacity of the food products. These components can be added while the myofibrillar/cytoskeletal proteins are solubilized/disorganized and/or along with the pH-adjusting solution. For example, acid-solubilized muscle proteins or protein isolates can be added to the solubilized/disorganized tissue. In some useful procedures, components obtained from a species of an animal are added to solubilized/disorganized tissue obtained from the same species.

Various ingredients can be added to the food product to improve the texture, water uptake and/or water holding capacity. Such ingredients are generally referred to herein as “texture-improving ingredients.” Texture-improving ingredients can be added along with acids, bases and/or buffers after solubilizing and optionally heating muscle tissue, and/or during or after optionally readjusting the pH of the muscle tissue. For example, one can add a texture-improving ingredient to an acid, base and/or buffer solution used to readjust the pH of the muscle tissue.

Suitable texture-improving ingredients include proteins or protein isolates prepared from, e.g., muscle tissue, soy protein, wheat protein or other food grade proteins. For example, acid-solubilized muscle protein isolates can be injected into muscle tissue that has been adjusted to a low pH (e.g., having a pH of no more than about 4.5, 4.2, 4.0, 3.5, or 3.0) to solubilize some or all of its myofibrillar and cytoskeletal proteins. Similarly, alkali soluble proteins can be incorporated into muscle tissue that has been adjusted to a higher pH. Likewise, insoluble proteins can be incorporated into the food product to improve the texture and/or water holding capacity of the food product. Injection of muscle protein isolates can result in improved texture in the final muscle food product. Muscle protein isolates can be prepared from, e.g., unwashed muscle tissues, e.g., containing myofibrillar and sarcoplasmic proteins, or from washed muscle tissue containing myofibrillar proteins and substantially no sarcoplasmic proteins. Methods for preparing proteins and protein isolates are known in the art and can be found, e.g., in U.S. Pat. Nos. 6,005,073, 6,136,959, 6,288,216, and 6,451,975.

The added agents, e.g., protein isolates, can play a role in controlling the viscosity of the food product. Alternatively, or in addition, viscosity can be controlled by adjusting salt concentration, protein concentration, and pH. A higher viscosity of the protein isolates themselves can be achieved, e.g., by raising the pH to a high value and then lowering it to a desired value. For example, a relatively high viscosity can be achieved when the protein isolate is exposed to pH 10 and then brought back to pH 9, than would be achieved if the isolate were adjusted to pH 9 directly. The viscosity of the protein isolates can be controlled by adjusting salt concentration and/or protein concentration, in addition to pH.

The viscosity and dispersment of the protein isolates can be controlled with use of buffers and/or pH. Optimizing viscosity and dispersment of the protein isolates allows them to pass through an injection needle and yet add viscosity to the food product. The viscosity of some protein isolates for injection can be from about 300 kPa to about 100,000, from about 500 kPa to about 250,000 kPa, from about 1000 kPa to about 200,000 kPa, or from about 10,000 to about 200,000 kPa.

Calcium chloride can also be added as a texture improving ingredient, with or without an organic acid (e.g., citric acid). Calcium may be involved in directly breaking down some proteins, or may activate certain proteolytic enzymes that will break down these proteins. Further, lowering the pH with an organic acid will retard lipid oxidation, thereby reducing the so-called “warmed over flavor” problem observed in many products after they have been cooked. Addition of calcium chloride can improve the antioxidative effect of the organic acid. Typically, such effects are seen at final concentrations of calcium chloride in the tissue water (e.g., at levels of calcium chloride uptake resulting in the concentration of calcium chloride in the water of the food product) of no more than about 10 mM (e.g., no more than about 8 mM, no more than about 6 mM, no more than about 4 mM, or no more than about 2 mM), in conjunction with organic acids in concentrations of no more than about 10 mM (e.g., no more than about 8mM, no more than about 6 mM, no more than about 4 mM, or no more than about 2 mM). Treatment at pH values higher than neutrality also can have an effect of delaying and/or inhibiting the development of warmed over flavor. These protections at acid and alkaline pH surprisingly are maintained even if the tissue is adjusted back to its initial pH, e.g., beef at pH about 5.5.

Other ingredients can be added, for example, flavorants (e.g., herbs and/or spices), antioxidants, vitamins, and/or minerals.

### 4. Re-Adjusting pH of the Muscle Tissue

The heated (e.g., cooked) food product can be, optionally, adjusted to any desired pH, e.g., back to its initial value. In some instances, the pH can be adjusted to a desired value before heating, e.g., cooking. In some instances, no heating is carried out. Adjusting the pH to be more basic can help to avoid or reduce acidic taste in the muscle tissue if any would be otherwise detectable by a consumer. This can be achieved by injection, mixing and/or soaking the tissue (e.g., intact or minced tissue), in a basic solution, e.g., pH-adjusting solution described above. Upward adjustment of pH can be accomplished using any base, e.g., sodium hydroxide, sodium carbonate, sodium bicarbonate, appropriate phosphate salts (e.g., polyphosphates such as, for example, sodium acid pyrophosphate, sodium tripolyphosphate, or sodium hexametaphosphate), and/or amino compounds such as amino acids (e.g., glycine, cysteine, hydrolyzed protein(s)). Buffers can be used to control and stabilize the pH. The basic pH-adjusting solution can be introduced to the food product in any of the ways described above. Basic solution can include ingredients that improve flavor characteristics such as meat, poultry, or fish broth and/or spices.

For example, where the pH of muscle tissue is decreased to a very low level, the pH can be re-adjusted in a multi-step (e.g., a two-step) process. For example, the pH of the muscle tissue can first be raised by the injection of a basic solution and tumbled to aid in the uptake and distribution of the basic solution, and can then be re-injected with the same or a different basic solution, optionally followed by further tumbling. In another example, the pH of the muscle tissue generally can be adjusted by injection with a basic solution, optionally with tumbling, followed by soaking the muscle tissue in a basic solution, optionally having a different pH than the initial basic solution, to evenly adjust the pH of the exterior portions of the muscle tissue and the interior portions of the muscle tissue. Uptake of the pH-readjusting solution, and resultant change in pH, is typically lower in cooked muscle as compared with raw muscle.

### Alkaline Process

A process similar to that described above can be carried out utilizing an alkali solution to disorganize the structure of the food product, e.g., solubilize and/or disorganize myofibrillar and/or cytoskeletal proteins of the food product. Adjusting pH of the food product can be carried out by combining the food product with a pH-adjusting solution described above. The pH-adjusting solution can include bases and/or buffers described herein. Similar to the acidic process, a single or a double pH adjustment can be carried out. The food product can optionally be heated (before the optional pH adjustment to a third pH, or after the pH adjustment to a third pH).

### 1. Specific Properties of the Alkaline Process

Changes in tenderness and water-holding capacity generally occur more abruptly at acid than at alkaline pH because substantially all of the proteins solubilize and/or dissociate at about a single acidic pH value, whereas different proteins solubilize and/or dissociate at different basic pH values. Without being limited by theory, this is believed to be due to the fact that there is only one major side chain on the proteins (a carboxylate side chain) with a pKa value below 5.5 (the isoelectric point of the meat proteins), while there are groups with a wide range of pKa's on the basic side. Solubilization on the acid side occurs abruptly, while important changes on the alkaline side can occur before there is complete solubilization, as described in Hultin, H. O. et al., A Re-Examination of Muscle Protein Solubility, J. MUSCLE FOODS 6, 91-107 (1995).

Accordingly, in the alkaline process, modification of the muscle can optionally be produced by first solubilizing proteins that maintain the structure of the thick filaments and Z-disks, referred to herein as “possible solubility-inhibiting polypeptides” or “PSI polypeptides.” Solubilization of these proteins may remove restraints on expansion of the myofibrillar proteins. The myofibrillar proteins can then expand because of the present electrostatic repulsive forces, resulting in an increase in water-holding capacity by creation of a gel pressure. An increase in water content can decrease mechanical toughness of muscle tissue. Thus, the pH of muscle tissue can be increased until a sufficient amount of PSI polypeptides have been solubilized to remove restrictions on separation of the insoluble myofibrillar proteins and facilitate the charge repulsion forces. Such limited amount of solubilization can lead to increased moisture content (when water is added) and a decrease in toughness.

The pH at which these changes occur is generally in the range from 6.7 to 7.2, and most likely involves the histidyl amino acid side chain (imidazole). At higher pHs, the net negative charge on the proteins increases as groups with higher pKa's lose their protons; cysteine at pH 8, amino groups at pH 9, tyrosine at pH 10.5, and arginine at pH 12.5. This increase in net negative charge may eventually lead to solubilzation of all the myofibrillar and cytoskeletal proteins, which will cause maximum water uptake (when water is added) and tenderization.

### 2. Disorganizing Structure of a Food Product

Intact or minced food product (e.g., protein, e.g., muscle protein, within food product) can be combined with a pH-adjusting solution (e.g., base and/or buffer) to raise the pH of the food product. The pH of the food product is raised to a level sufficient to change or disorganize the structure of the food product, e.g., muscle food product, e.g., to solubilize at least some of the myofibrillar and/or cytoskeletal proteins (e.g., to solubilize substantially all of the myofibrillar and/or cytoskeletal proteins) in the muscle tissue. In some instances, the myosin, myofibrils, and/or Z-disc structures of the muscle food product can become altered or disorganized. Detection or measurement of food product and/or protein disorganization can be carried out by methods known in the art as discussed above. The pH of the muscle tissue can be raised, e.g., to at least about 6.8 (e.g., at least about 7.2, 8.0, 9.0, 9.5, 10.0, 10.5, 11.0, 11.5) (e.g., to about 6.8, 7.2, 8.0, 9.0, 10.0, 10.5, 11.0, or 11.5).

a. pH-Adjusting Solution

The pH of the food product, e.g., muscle tissue, can be raised using pH-adjusting solutions described above in the “Acid Process,” e.g., adjusting solutions comprising bases and/or buffers described above. Suitable pH-adjusting solutions include bases, e.g., strong bases, e.g., sodium hydroxide and/or potassium hydroxide, and/or weak bases, e.g., sodium carbonate, sodium bicarbonate, and/or appropriate phosphate salts (e.g., polyphosphates such as, for example, sodium acid pyrophosphate, sodium tripolyphosphate, or sodium hexametaphosphate). pH-adjusting solutions can include amino compounds such as amino acids (e.g., glycine, cysteine, hydrolyzed protein(s)).

It can be challenging to get enough base into a food product without exposing the tissue to extremely high pH values (if it is undesirable to do so). To address this potential issue, buffers modified in ways described above can be used. As discussed above, pH of a buffer can be raised or lowered one pH unit above/below its pKa, offering various advantages. Such buffer can serve as a useful storage compound of hydroxyl ions and accept enough base to achieve the desired pH change in the muscle tissue with low generation (if any) of potential chemical breakdown products. For example, compounds with pK's of approximately 8-10 (e.g., glycine (pK 9.6), polyphosphates such as sodium acid pyrophosphate (pK 9.5) or sodium tripolyphosphate (pK 9.9)) are useful as buffers.

As another example, skilled practitioners will appreciate that, at neutral pH, glycine has a negative charge on its carboxylate group and a positive charge on its amino group. If this compound is titrated with base to a pH approximately one unit past its pK (about 10.6), approximately 91% of the acidity of the amino group is removed. This free amino group then can serve as a base that can interact with naturally-occurring buffers in the muscle tissue to adjust the pH upward without unduly damaging muscle tissue by exposure to a high concentration of free hydroxyl ions.

b. Methods of Adjusting pH

The pH of food products can be raised using any method known in the art and/or described above, e.g., by combining the muscle tissue with a pH-adjusting solution, e.g., a base (e.g., a basic solution) and/or buffer, by injection, soaking, mixing and/or tumbling. The distribution of base through the food product can in certain embodiments be aided by application of a vacuum.

The pH of a food product can be adjusted in several steps. For example, where a large pH change is sought, the total amount of alkali pH-adjusting solution required can be separated into multiple portions and injected sequentially with time and the food product can be optionally tumbled and/or vacuum applied to aid in distributing the portion of the alkaline solution before adding the next portion. This can be useful, for example, where a stronger base is used, or where a large quantity of base is used, to prevent over-basification of the area localized near the point of injection. In some instances, the pH of the food product can be adjusted in about 20 minutes (e.g., about 15 minutes, about 10 minutes, or about 5 minutes).

In some instances, the pH of the muscle tissue can be raised to about 12.0 (e.g., no more than about 11.5, no more than about 11.0, no more than about 10.5, or no more than about 10.0, e.g., about 11.5, 11.0, 10.5, or 10.0) to avoid chemical breakdown products. Breakdown products may arise slowly at pH's up to about 11, can be somewhat accelerated at pH of between about 11 and about 12, and may undergo a very rapid increase when the pH is 13.

### C. Titration

The amount of base to be added to a food product can be determined by titration, as discussed above. Generally, the concentration of base solution to be injected into intact tissue or mixed with minced muscle tissue to achieve the desired pH will depend on the volume of the base solution that is to be added to the muscle tissue.

For example, prior to addition of the base to a large batch of food product, e.g., muscle tissue, a sample of the muscle tissue (e.g., homogenized tissue) can be titrated with a strong base (e.g., sodium hydroxide) to determine how much base is required to reach the desired pH. Then, a corresponding solution of glycine of sufficient concentration to provide the calculated amount of base can be prepared. A sufficient volume of the glycine solution can then be injected into muscle tissue. This process can raise the pH of the food product to a desired pH with reduced (if any) level of potential chemical breakdown products.

### 3. Heating the Food Product

Food product injected, soaked, and/or tumbled with a basic solution can optionally be heated using any art known method, e.g., any of the techniques described above, to set the proteins. In some instances, the food product can be heated following raising of its pH. In others, pH can be readjusted prior to heating. Distribution of base can be accelerated if the food product is tumbled after injection, optionally under vacuum, either before or after cooking. In certain instances, adjustments of pH of the outer section of the food product is most easily done by tumbling with a basic adjusting solution (e.g., in an amount of alkali solution that totals from about 10 % by weight to about 20 % by weight of the total food pr6duct used to adjust the pH). The solution can contain salts (e.g., sodium chloride (NaCl), potassium chloride (KCl), other potassium salts, or calcium chloride (CaCl₂), or mixtures thereof) to control protein solubilization and water uptake. The solution may in some instances have no more than about 300 millinormal (mN) salt (e.g., no more than about 200 mN salt, no more than about 150 mN salt, no more than about 100 mN salt, or no more than about 50 mN salt).

### 4. Addition of Texture-Improving Ingredients

Other water holding agents (e.g., proteins and/or polysaccharides) can be added to improve texture and water holding capacity of the muscle tissue as described above under “Acid Process.”

### 5. Re-Adjusting the pH of the Muscle Tissue

The pH of the food product can be optionally re-adjusted, e.g., to its initial (e.g., natural) pH, by tumbling, soaking and/or injecting the muscle tissue with an acidic solution, e.g., a pH-adjusting solution described herein, with or without the aid of a vacuum, using any of the techniques described herein. pH can be re-adjusted prior to, or following heating the food product. pH can be re-adjusted without heating the food product. For example, the food product can be injected with an acid, for example, an organic acid (e.g., citric, lactic, or malic acid) that is generally recognized as safe (referred to hereinafter as “GRAS”) for food use. The injection process works well for interior tissue. As another example, the food product can be tumbled with or soaked in a solution including an inorganic acid (e.g., hydrochloric, sulfuric, and/or bisulfuric acid). The food product can be tumbled in an acidic solution, e.g., 5-30 % of the weight of food product, that has a pH close to that of the desired final value. For example, this acidic solution could be at a pH of 6.5 to reach a final pH of 7.0. Tumbling may aid in adjusting the pH of the surface tissue.

In some instances, where the pH of the food product is elevated to a high level (e.g., at least about 9.0, at least about 9.5, at least about 10.0, at least about 10.5, or at least about 11.0), the pH can be re-adjusted in a multi-step (e.g., a two-step) process as described above for an acidic process, but with use of basic solution(s).

Skilled practitioners will appreciate that various individual steps of the methods described herein can be performed by the same or different parties. For example, the entire method can be performed by the same party, e.g., pH adjustment (single or double) and heating can be carried out, e.g., at a food processing facility and then distributed to consumers. Alternatively, a food product whose pH has been adjusted by the present methods (e.g., with single or double pH adjustment) can be packaged and distributed, e.g., sold, to a consumer, who might then heat the product. The present application contemplates all such variations.

### EXAMPLES

The invention is further described in the following examples, which do not limit the scope of the invention described in the claims.

### SECTION 1.

The effect of double pH adjustment on the water-holding capacity and tenderness of beef muscle by injection and soaking to a favorable condition, cooking, and then injecting and soaking to the desired final pH.

### EXAMPLE 1

### The Effect of Double pH Adjustment on Beef Muscle Properties Where the First Adjustment is Lowering the pH

Beef eye round muscle was cut into cylinders of 20 mm in diameter and 18 mm in height along the muscle fiber direction. The muscle samples were divided into five groups: (1) samples injected/immersed in 10 mM citric acid; (2) samples injected/immersed in 10 mM citric acid, cooked, and neutralized with base; (3) samples injected/immersed in 10 mM citric acid, neutralized with base, and cooked; (4) samples immersed in CaCl₂; and (5) control samples.

The cylinders of groups (1)-(3) were first injected with about 10% of 85 mM citric acid on the basis of green weight and then immersed in 10 mM citric acid. The uptake of marinade was between 33.8% and 30.4% when the beef cylinders were marinated in 10 mM citric acid for 2 days. When the pH was neutralized to 5.36 by immersion in 15 mM sodium tripolyphosphate before cooking (group 3), most of water uptake from the acid marinade was lost. The beef muscle cylinders immersed in 10 mM CaCl₂ for 2 days (group 4) did not absorb any water.

The cook yields in the beef muscle treated with citric acid alone (group 1) were 98.3% and 97%, respectively. When the acid-treated muscle was immersed in the base solution after cooking (group 2), the cook yield decreased from 97% to 89.2%. If the acid-treated muscle was immersed in the base solution before cooking (group 3), a low cook yield of 51.6% was achieved. The cook yield of the beef muscle treated with CaCl₂ (group 4) was 57.2%.

The neutralization of the acid-treated muscle before cooking (group 3) decreased the moisture content compared to the same acid-treated muscle without neutralization and gave a minimum moisture content of 61.1%. The moisture contents in the cooked beef muscle treated with citric acid with or without neutralization after cooking were 76.9% and 77.2%, respectively, and these values were significantly higher than the others (p≦0.05). The moisture content of the beef treated with CaCl₂ was 63.7% which was lower than the untreated control, but the difference between them was not significant (p>0.05).

The beef cylinders lost about 9% of its total protein to the acid marinade, and the protein loss of beef immersed in 10 mM CaCl₂ was 26.2%.

The shear force value decreased from 34.4 Newton in the control without treatment, to 15.4 Newton in the beef treated with citric acid alone and cooked in its acid condition. As the pH was readjusted to 5.36 before cooking (group 3), the shear force value increased to 41.5 Newton. As the pH was readjusted to 5.21 after cooking (group 2), the shear force value was 20.3 Newton, which was significantly lower (p≦0.05) than that in the beef neutralized before cooking. The immersion in 10 mM CaCl₂ increased the shear force value compared to the control, but the difference was not significant (p>0.05). The moisture content of the cooked beef was lower and the shear force was higher in the samples brought to the low pH and re-adjusted to about their original pH before cooking (group 3) as compared to the untreated control.

Thus, cooking beef samples at pH below 4, before re-adjusting the samples with base to the original pH (group 2), improved (i.e., reduced) the Warner-Bratzler shear force (WBSF) of the samples, making them more tender. Group 2 also showed an improved cook yield, i.e., the samples held more water. In some cases, the same improvements can be seen if the samples are cooked at pH 4.0 to 4.5 before re-adjusting their pH to a more basic value.

### EXAMPLE 2

### The Effect of Double pH Adjustment on Beef Muscle Properties Where the First Adjustment is Raising the pH

The results of Example 1 have shown that re-adjustment of acid-treated beef muscle back to its initial value before or after cooking affected the water-holding capacity and tenderness of the beef muscle. Next, the changes in the water-holding capacity and beef tenderness were investigated, where the pH of beef muscle was first brought to neutrality and then brought down to the initial value of raw beef before and after cooking. The beef cylinders were divided into four groups for treatment: (1) control, no treatment; (2) 25 mM STPP at pH 8.4; (3) 25 mM STPP at pH 8.4, followed by cooking and then neutralization; (4) 25 mM STPP at pH 8.4, followed by neutralization, and then cooking.

The beef cylinders of groups (2)-(4) were first injected with ˜10% of 250 mM sodium tripolyphosphate (STPP) on the basis of their green weights and immersed in 25 mM STPP at pH 8.4 for 2 days. The pH of beef after base immersion was between 6.67 and 6.81. Then, one group (group 4) of base-treated samples were immersed in 10 mM citric acid at pH 4.26 for 42 hours before cooking. The pH of the beef after acid treatment was 4.8. Another group of base-treated samples (group 3) were cooked at 70° C. for 50 minutes and then immersed in 10 mM citric acid at pH 4.37 for 42 hours; the pH of the cooked beef after acid treatment was 4.95.

The beef treated with the basic solution alone had the highest moisture content of 76% after cooking. Lowering the pH by acid treatment to pH 4.95 after cooking (group 3) resulted in a moisture content in the cooked beef of 68.9% compared to the value of 67.1% in the sample cooked after pH was readjusted and to a value of 76.0% in the cooked sample brought to pH 6.79 with no re-adjustment of pH. 1s The control sample without treatment had the highest shear force value of 37.3 Newton. The shear force value decreased to 25.2 Newton when beef cylinders were immersed in phosphate buffer and cooked at pH 6.79. Re-adjusting the pH to 4.95 after cooking gave a shear force value of 30 Newton. This was significantly lower than that in the control without treatment (p≦0.05).

The uptake of marinade during the base treatment was between 24.8% and 29%. If the pH was brought down to 4.8 by acid marination, most of water uptake from the basic solution was lost and a cook yield of 54% was obtained. Maximum cook yield of 77.6% was achieved in the beef sample treated with the basic solution alone, while the sample cooked before re-adjustment had a cook yield of 72.3%.

Thus, both cook yields and WBSF were improved in the alkaline experiments at pH values where there was only a partial solubilization of the muscle proteins. When the pH was raised to a point, e.g., 10.5, where most of the proteins are solubilized, similar results were obtained when the samples were re-adjusted to their original, lower pH.

### CONCLUSIONS FOR EXAMPLES 1 AND 2

As the pH of beef muscle was brought to acid value (below pH 4.0) or neutral value (around 6.8 to 7.0) by injection and immersion with the acid or basic solution, the cook yield and moisture content after cooking increased and the Warner-Bratzler shear force value decreased compared to those in the control, indicating that the water-holding capacity and tenderness increased after acid or base treatment. Returning the pH to its initial value had a strong effect on the water-holding capacity and tenderness of beef muscle.

The moisture content in the beef treated with base was significantly higher than that in the control (p≦0.05). Most of the uptake was lost when the acid- or base-treated muscle was re-adjusted to around its initial pH before cooking. Moisture contents in the beef with double pH adjustment (increased with basic pH-adjusting solution and then decreased with acidic pH-adjusting solution) before cooking were significantly higher than that in the control (p≦0.05). Moisture contents in the beef with double pH adjustment (decreased with acidic pH-adjusting solution and then increased with basic pH-adjusting solution) before cooking was lower than in the control. When the beef muscle was re-adjusted to approximately its initial pH after cooking, a small amount of weight was lost but the final moisture content was still higher than that in the control.

The shear force value in the beef treated with 10 mM citric acid alone was around 45%. The shear force value in the beef treated with 25mM sodium tripolyphosphate was 68% of that in the control (Experiment 2). If the beef muscle was re-adjusted to the initial pH of the raw beef (around 5.5) before cooking, the shear force value increased to the level in the control or even higher than that in the control. If the beef muscle was re-adjusted to the initial pH of raw beef after cooking, the shear force value increased compared to that treated with acid or base without pH re-adjustment but was significantly lower than that in the control (p≦0.05).

### SECTION 2

### The Effect of Acids and Salts on Properties of Cooked Beef

### EXAMPLE 3

### The Effect of Various Concentrations of Calcium Ions, Sodium Ions, Citric and Lactic Acid, and Phosphates on Water-Holding Capacity and Shear Force of Cooked Beef

Syringes with needles of gauge 25 and outside diameter of 0.51mm (BD*Disposal Syringes, Cat. No. 309582, Fisher Scientific, Pittsburgh, Pa.) were used to inject the solution into the muscle. The concentration of reagents in the injection solution was 8.5 times those in the marinade. This was to obtain approximately the same concentrations of the components in the aqueous phase of the beef muscle as used in the soaking solutions. Calculations were based on an initial moisture content of 74%. Beef cylinders were injected at about 10% of green weight (uninjected weight). Weights were taken before and immediately after injection. Then, injected cylinders were immersed in marinades. In each treatment, there were 10˜12 cylinders. About 50 g of cylinders were immersed in 1 liter of marinades for 24 days. For double pH adjustment, beef cylinders were injected with the second solution and immersed in the second marinade for 1 day, except in certain experiments.

The addition of sodium chloride up to 150 mM to the acid marinade decreased the moisture content and cook yield and increased the shear force values compared to the same treatment without salt. The shear force in the sample treated with 10 mM citric acid plus 10 mM CaCl₂ in the presence of salt (25.8 Newton) was significantly lower than that of the untreated control (43.7 Newton). Lactic acid also performed well, but CaCl₂ reduced its effectiveness, contrary to the results with citric acid.

### SECTION 3

Enhancement of Muscle Foods by Injection/Tumbling with Protein Isolate Prepared from Muscle Tissue

### EXAMPLE 4

### Effect of pH of Protein Isolate (PI) Prepared by the Alkaline Process in the Injected Solution on Cook Loss of Cooked Cod Methods

5% cod PI, with different pHs and added 620 mM NaCl and 25 mM NaHCO₃ were injected into various cod samples.
pH's of the PIs used were 7.5, 9.0, 10.0 and 10.5.
Cod samples were cut from the head part of the fillet. Five samples for each category (each pH category of the PI) were used.
Cooking of cod samples injected with four types of PIs was 80° C. for 20 minutes in vacuum sealed bags.

The results are presented in Table 1 below.

TABLE 1
Averages:

pH of PI

| | | | |
|---|---|---|---|
| 7.5 | 9.0 | 10.0 | 10.5 |

Injection Average (based on green wt)

| | 14.7 | | 14.6 | | 15.9 | | 14.6 | | control |
|---|---|---|---|---|---|---|---|---|---|
| | Average | STDV | Average | STDV | Average | STDV | Average | STDV | Average |
| % Yield | 83.9 | 1.4 | 88.3 | 3.5 | 89.9 | 3.7 | 90.4 | 2.7 | 78.3 |
| % Cook | 26.8 | 1.3 | 23.0 | 2.7 | 22.4 | 3.1 | 21.4 | 2.0 | |
| Loss | | | | | | | | | |

*Control is cooked sample without any treatment.
% Yield = 100 × weight after cooking/green weight
% Cook Loss = 100 × (weight before cooking − weight after cooking)/weight before cooking

### Results

The results show an increasing pattern in water holding with increasing pH of injected PI, but there was no significant difference between pH 9, 10 and 10.5. Samples injected with pH 7.5 PI, showed a significant decrease in water holding after cooking from samples at the higher pH values.

### EXAMPLE 5

### Effect of Viscosity of PI Solution on Cook Loss After Cooking Methods

5% cod PI, with different pHs and added 620 mM NaCl and 25 mM NaHCO₃ were injected into samples of cod.
To achieve a higher viscosity at desired pH, pHs of PI suspensions were adjusted to 10 and then brought down to a desired pH.
Cod samples were cut from the head part of the fillet. Five samples for each category (each PI category) were used.
Cooking of cod samples injected with PI: 80° C. for 20 minutes in vacuum sealed bags.

The results are presented in Tables 2-3 below.

TABLE 2
Averages:

| | 7.5 | | 10-7.5 | | |
|---|---|---|---|---|---|
| | Viscosity mPa · s | | | | |
| | 375 | | 3170 | | |
| | Injection Average (based on green wt) | | | | |
| | 13.8 | | 14.4 | | control |
| | Average | STDV | Average | STDV | Average |
| % Yield | 83.8 | 1.5 | 85.0 | 1.3 | 78.3 |
| % Cook Loss | 26.4 | 0.9 | 25.7 | 0.7 | |

*Control is cooked sample without any treatment.
% Yield = 100 × weight after cooking/green weight
% Cook Loss = 100 × (weight before cooking − weight after cooking)/weight before cooking
Viscosity was measured using Brookfield Eng. Viscometer Model DV-E spindle L3 at 10 rpm

TABLE 3

| | 9 | | 10-9 | | |
|---|---|---|---|---|---|
| | Viscosity mPa · s | | | | |
| | 4290 | | 7680 | | |
| | Injection Average (based on green wt) | | | | |
| | 13.9 | | 14.0 | | control |
| | Average | STDV | Average | STDV | Average |
| % Yield | 92.1 | 1.9 | 91.9 | 1.0 | 85.7 |
| % Cook Loss | 19.2 | 1.1 | 18.9 | 1.0 | |

*Control is cooked sample without any treatment.
% Yield = 100 × weight after cooking/green weight
% Cook Loss = 100 × (weight before cooking − weight after cooking)/weight before cooking
Viscosity was measured using Brookfield Eng. Viscometer Model DV-E spindle L3 at 10 rpm

### Results

PIs were brought up to pH 10 in order to promote dispersability and increase viscosity. There was no significant difference on water holding caused by the increased viscosity.

### EXAMPLE 6

### The Effects of Protein Injection and Tumbling on Shear Force and Moisture Content of Beef Eye Round

### Methods:

### Procedure for Making Protein Isolate

Beef eye round was cut into pieces small enough to fit into a meat grinder. The meat was passed through the meat grinder twice. The ground beef was then blended in a 1:5 ratio with cold water. The pH of the beef suspension was brought up to 10.8 using 2 N NaOH and allowed to sit for 15 minutes. After 15 minutes, the pH of the suspension was again brought to 10.8 and allowed to sit for another 15 minutes. Using a mesh screen, the insoluble connective tissue was filtered off. After the connective tissue was filtered off, the pH of the protein solution was brought down to pH 5.5 using 1 N HCl. Using a mesh, most of the water was filtered out of the protein isolate. The protein was then put into cheese cloth and squeezed to reduce moisture content. The isolate was divided into 100 g portions and frozen at −80° C. All of the above steps were carried out either on ice or in a 4° C. room. Other types of muscle tissue could be treated in the same way.

### Preparation of Injection Solution

A 100 g portion of the protein isolate was thawed and then mixed with cold deionized water in a 1:1 ratio in a 4° C. room. The mixture was blended for 20 seconds using a blender, and then it was homogenized for 20 seconds using a polytron homogenizer. A small sample of the protein suspension was diluted 1:5 with cold deionized water in order to apply the biuret method for determining the protein content. When the protein content was known, the protein solution was adjusted to 5% and pH 9.0 with 600 mM NaCl and 25 mM sodium carbonate. In order to adjust the pH to 9.0, 2N NaOH was used, and then cold deionized water was added to obtain a final protein content of 5%. In this experiment, the protein isolate solution was 4.89%.

### Results

The viscosity of these suspensions is presented in Table 4 below.

TABLE 4
Viscosity of Injection Solution

| Speed (RPM) | MPa · s |
|---|---|
| 10 | 9340 |
| 6 | 11980 |
| 5 | 13100 |
| 4 | 14910 |
| 3 | 17560 |
| 2.5 | 19390 |
| 2 | 21540 |
| 1.5 | 24880 |
| 1 | 31400 |
| 0.6 | 42400 |

### SECTION 4

### The Warmed-Over Flavor Problem

### EXAMPLE 7

### Inhibition of Warmed-Over Flavor in Cooked Beef Muscle as Affected by pH Adjustments

Warmed-over flavor (WOF) is a form of oxidative rancidity that develops in cooked meats during storage. Our studies, some of which are described herein, have shown that beef tenderness can be improved if the pH of beef muscle was adjusted to a value below about pH 4 or to a neutral value or above by injection or injection/immersion with or without and tumbling. The measurement of 2-thiobarbituric acid-reactive substance (TBARS) is a widely used method to detect lipid oxidation since 2-thiobarbituric acid since it reacts with carbonyl compounds produced during lipid oxidation.

The TBARS measurements of groups of beef at various pH (injected and/or tumbled) are shown in Table 5 below. MDA indicates malonaldehyde. All samples were vacuum-packed and cooked at 70° C. for 50 min. They were then stored for various amounts of time at 5° C.

TABLE 5
TBARS (μmol MDA/kg cooked beef) after cold storage

| | |
|---|---|
| Initial moisture | TBARS |
| content after | (μmol MDA/kg cooked beef) |

| | cooking, % | 0 hr | 25 hr | 48 hr | 168 hr |
|---|---|---|---|---|---|
| Control | 62.2 | 1.52 | 24.0 | 35.5 | 87.8 |
| pH 7.5 | 70.8 | 0.28 | 0.46 | 0.87 | 1.5 |
| pH | 68.2 | ~0 | 0.44 | 0.71 | 1.53 |
| 10.5→ 7.5 | | | | | |
| pH 10.5 | 76 | 0.57 | 0.74 | 1.45 | 20.4 |
| pH | 60.2 | 0.21 | 0.27 | 0.36 | 5.17 |
| 10.5→ 5.5 | | | | | |

The formation of warmed-over flavor of cooked beef muscle after acid treatment is shown in Table 6. The beef sample was first injected with 20% of 0.3 M citric acid on the basis of green weight and vacuum tumbled with 20% of the same solution for 30 min. Then the beef sample was cooked at 70° C. for 50 min, cooled down and stored at 5° C., and TBARS during storage was followed.

TABLE 6
TBARS (μmol MDA/kg cooked muscle) development during
storage at 5° C. in cooked beef samples

| Storage time | | | Control: w/o | Control w/ |
|---|---|---|---|---|
| h | pH 3.5 | pH 3.5 → 5.5 | tumbling | tumbling |
| 0 | 3.7 | 3.3 | 7.3 | 7.9 |
| 3 | 3.8 | 3.3 | 6.8 | 6.1 |
| 20.5 | 4.6 | 4.8 | 8.9 | 16.6 |
| 49.5 | 4.1 | 2.3 | 15.9 | 32.8 |
| 74.5 | 3.6 | 3.4 | 26.5 | 47.0 |
| 97.5 | 4.1 | 3.3 | 48.5 | 63.5 |
| Initial | 65.8 | 57.4 | 59.4 | 60.5 |
| moisture | | | | |
| content after | | | | |
| cooking % | | | | |

### Conclusions

The formation of warmed-over flavor during cold storage of cooked beef muscle could be inhibited or retarded by adjusting the pH of the muscle. In the control without treatment, TBARS increased above 20 μmol MDA/kg of cooked muscle within one or two days. If the pH of beef was brought to 3.5 and 7.5, TBARS did not change much and was below 5 μmol MDA/kg of cooked muscle at 97.5 hours of storage. Double pH adjustments, for instance, from 10.5 to 7.5, 10.5 to 5.5 and 3.5 to 5.5, could also retard the formation of warmed-over flavor. Tumbling itself affected the oxidation of beef muscle. Beyond 20.5 hours of storage, the control after tumbling had higher TBARS than that without tumbling.

### SECTION 5

### Additional Experiments

### EXAMPLE 8

### Consistencies of Protein Isolate Solutions

Consistency measurements were done using a Brookfield Engineering Digital Viscometer model DV-E with a L3 spindle. Protein isolate solutions were prepared as 200 ml and pH adjustments were done using 2M NaOH, and 3M HCl solutions. Protein isolate solutions had a pH of ˜5.5 at the time of the preparation. Consistencies were measured as the pH of the solutions hit a desired pH value. Time between two pH adjustments was about 3 to 5 minutes.

As the pH increased, consistency of a protein isolate solutions increased. This increase became sharper after pH 9. Lowering the pH after a certain value, did not decrease the consistency of the solution back to its previous consistency value at the same pH. Without being limited to a particular theory, this may be due to the swelling or the solubilization of the outer parts of the protein clusters with pH and interacting with the neighboring clusters.

Consistencies of protein isolate solutions also increased with time. As the pH adjusted protein isolate solutions were incubated at 5° C., their consistency increased. Without being limited to a particular theory, this may be due to the increasing swelling and protein cluster interactions due to the penetration of ions, deeper into the clusters, with time, and ionizing and/or shielding or protein side chains.

### EXAMPLE 9

### The Effect of Citric Acid and Calcium Chloride Added to Minced Cod

### Objective

The aim of this experiment was to study the effect of citric acid and calcium chloride added to minced cod. The oxidation of protein isolates prepared from unwashed cod with citric acid and calcium chloride was also studied. Two pH controls (i.e., samples treated at low or high pH without the addition of citric acid and calcium chloride) were included in the samples.

### Results

It was observed that unwashed cod had a longer lag phase compared to the washed control, i.e., 3 days.

Addition of citric acid and calcium chloride to unwashed cod offered very good stability against lipid oxidation.

Acid treatment alone of unwashed cod was effective in reducing lipid oxidation compared to the untreated control. Citric acid and calcium chloride treatment of samples prior to acid or alkali solubilization enhanced oxidation stability even more.

### EXAMPLE 10

### The Use of Glycine to Reduce Acid Flavor in Acid-Treated Meat

### Objective

Intensity of acid flavor was compared in beef at pH 4.5 from samples double pH-adjusted using glycine at pH 2.0; samples which were treated only with glycine at pH 2.0; and samples which were treated with lactic acid.

### Methods

A beef eye round roast was ground once using a meat grinder. 20 g of ground beef was used for each different pH treatment. The pH of the beef samples was then adjusted using one of the two different acids. One sample was adjusted a second time using sodium carbonate. The samples were allowed to sit for 30 minutes after the pH of the ground beef was adjusted. 20 g of each pH treatment was weighed and formed into a meatball. The meatballs were then vacuum packed, which formed them into shapes more like footballs. The beef samples were then cooked at 70° C. for 50 min. After cooking the beef samples were tasted.

### Results

TABLE 7
results of a 9/20 experiment

| Treatment | pH | Acid flavor right after cooking |
|---|---|---|
| pH 3.9 (G); | 4.38 | Highest acid but SC makes it |
| pH 4.5 (SC)¹ | | taste better |
| pH 4.5 (G)² | 4.66 | Least acidic |
| pH 4.5 (LA)³ | 4.62 | Middle acid |

¹15% of the green weight of 1200 mM glycine at pH 2.0 was added to the beef sample. 15% of the green weight of 167 mM sodium carbonate was added to the beef samples.
²15% of the green weight of 510 mM glycine at pH 2.0 was added to the beef samples.
³15% of the green weight of 400 mM lactic acid was added to beef samples.

Glycine had less acidic taste than lactic acid.

### EXAMPLE 11

The Effects of Injection of Protein Isolate Suspensions on Properties of Cooked Muscle Foods under Various Conditions

### Methods:

1. Injection of Solutions into Muscle

Protein isolate suspensions were injected into the muscle using latex free needles gauge 20. Salt solutions were injected into the muscle with gauge 25. Syringes were made by BD (Franklin Lakes, N.J.). Syringes were pulled back out of the muscle slowly, while a little pressure was applied to the syringe for constant solution flow out of the needle.

2. Cooking injected muscle samples

Samples were cooked in vacuum-sealed polystyrene bags in a Napco model 210 A (NAPCO Scientific Co., Winchester, Va.) water bath. Beef samples were cooked for 50 min at 72° C., chicken samples were cooked for 30 min at 72° C. and cod samples were cooked for 20 min at 80° C. in order to insure that the internal temperature of samples reached 80° C. for cod and 70° C. for beef and chicken. After cooking, bags containing the samples were put in an ice bath for 10 minutes. Samples were stored at refrigeration temperature overnight for further testing.

### 3. Determination of Waner-Bratzler Shear Force

Warner-Bratzler shear force determination was done on cooked cores as described by AMSA (1995) as follows: cores of cooked muscle were removed using a cork borer with an inner diameter of 12.7 mm. Cores were removed parallel to the longitudinal orientation of the muscle fibers. Each core was sheared once by a V-notch Warner-Bratzler meat shear instrument made by O-R Manufacturing Co. (Manhattan, Kans.). Maximum reading was recorder in Newtons.

The results for chicken are depicted in Tables 8-10 below. Beef and cod muscle and their respective protein isolates gave similar results.

TABLE 8
The effects of tumbling and incubation of injected chicken breast
muscle on cooking yields and cooking losses.

| | | Injection Solution and Treatment Before Cooking | | | | | |
|---|---|---|---|---|---|---|---|
| | | | | | | No protein | No |
| | | Protein Isolate Suspension¹ (pH 9.04) | | | | (pH 9.13) | Injection |
| Chicken | Added | 600 | 600 | 600 | 600 | 600 | — |
| Muscle | NaCl | | | | | | |
| | (mM) | | | | | | |
| | Time at | 0 | 4.5 | 4.5 | 4.5 | 4.5 | 4.5 |
| | 6° C. | | | | | | |
| | Tumbling² | N | N | Y | Y | N | N |
| | | | | | w/isolate | | |

| | | | | | | |
|---|---|---|---|---|---|---|
| % Injection³ | 15.7 ± 1.1 | 16.6 ± 2.2 | 15.8 ± 2.1 | 15.5 ± 1.0 | 15.3 ± 0.9 | — |
| Total Uptake Before | 15.7 ± 1.1^{a} | 16.6 ± 2.2^{a} | 14.9 ± 2.5^{a} | 19.9 ± 0.7^{b} | 15.3 ± 0.9^{a} | — |
| Cooking (%)⁴ | | | | | | |
| Cook Yield (%)⁵ | 101.5 ± 1.1^{b} | 99.0 ± 4.2^{bc} | 102.6 ± 2.0^{b} | 108.1 ± 1.5^{a} | 97.8 ± 1.5^{c} | 84.5 ± 2.3^{d} |
| Cook Loss (%)⁶ | 12.3 ± 0.8^{a} | 15.1 ± 2.1^{b} | 10.7 ± 0.6^{a} | 9.8 ± 0.8^{a} | 15.2 ± 2.3^{b} | 15.5 ± 2.3^{b} |
| Shear Force (N) | 5.2 ± 1.3^{a} | 6.8 ± 1.0^{b} | 5.8 ± 1.1^{ab} | 4.8 ± 1.2^{a} | 6.4 ± 1.1^{ab} | 11.8 ± 2.8^{c} |

Means with different letter within a column are significantly different (p ≦ 0.1)
Chicken breast muscle used for this experiment was Perdue brand with retained water up to 2%.
¹Protein source for the protein isolate was chicken.
²Tumbling: N is not-tumbled, Y is dry tumbled, and Y w/isolate is tumbled in the same protein isolate suspension (20% of green weight).
³% Injection = (Weight after injection − green weight)/green weight * 100.
⁴Total uptake before cooking (%) = (Weight before booking − green weight)/green weight * 100.
⁵Cook Yield (%) = (Weight after cooking/green weight) * 100.
⁶Cook Loss (%) = (Weight before cooking − weight after cooking)/weight before cooking * 100.

Table 8 above shows that injected protein isolate gave improved cook yields under all circumstances tested. Tumbling with excess protein isolate suspension gave the greatest improvement.

TABLE 9
The effects of protein isolate suspension salt concentration on
cooking yields of chicken breast muscle

| | Injection Solution and Treatment Before Cooking | | | | |
|---|---|---|---|---|---|
| | | | | | Protein |
| | | | | | Isolate |
| | | | | No | Suspension |
| Chicken | Protein Isolate Suspension¹ (pH 9.00) | | | Injection | (pH 7.5) |
| Added NaCl | 600 | 300 | 150 | — | 600 |
| (mM) | | | | | |
| % Injection² | 14.7 ± 0.4 | 15.3 ± 0.5 | 16.4 ± 1.1 | — | 15.8 ± 0.8 |
| Cook Yield (%)³ | 95.8 ± 1.5^{a} | 91.0 ± 0.6^{b} | 83.9 ± 2.2^{c} | 79.5 ± 2.0^{d} | 95.6 ± 1.3^{a} |
| Cook Loss (%)⁴ | 16.4 ± 1.6^{a} | 21.1 ± 0.5^{b} | 28.0 ± 2.2^{c} | 20.5 ± 2.0^{b} | 17.5 ± 1.1^{a} |
| Shear Force (N) | 6.1 ± 1.2^{c} | 6.3 ± 2.1^{c} | 10.6 ± 3.2^{b} | 16.4 ± 1.1^{a} | 7.5 ± 1.3^{bc} |

Samples were kept at 6° C. for 4.5 h in sealed bags after injection and before cooking. No Tumbling.
Means with different letter within a column are significantly different (p ≦ 0.1).
¹Protein source for the protein isolate was chicken.
²% Injection = (Weight after injection − green weight)/green weight * 100.
³Cook Yield (%) = (Weight after cooking/green weight) * 100.
⁴Cook Loss (%) = (Weight before cooking − weight after cooking)/weight before cooking * 100.

Table 9 above shows that injection of protein isolate with various salt concentration indicated that high salt (600 mM) gave the best results at both pH 7.5 and 9.0. All samples injected with protein isolate had lower shear force values.

TABLE 10
The effects of protein isolate suspension on cooking yields of
chicken breast muscle injected with protein isolate suspensions in the presence of
buffers

| | | Injection Solution and Treatment Before Cooking | | | | | | |
|---|---|---|---|---|---|---|---|---|
| | | | | | | | | No |
| | | Protein Isolate Suspension¹ (pH 10) | | | | No protein (pH 10) | | Injection |
| Chicken | Added | 200 mM | 200 mM | 200 mM | 200 mM | 200 mM | 200 mM | — |
| | Buffer | Glycine | Glycine | Na₂HPO₄ | Na₂HPO₄ | Glycine | Na₂PO₄ | |
| | Added | — | 1000 | — | 1000 | — | — | — |
| | Salt | | | | | | | |
| | (mM) | | | | | | | |

| | | | | | | | |
|---|---|---|---|---|---|---|---|
| % Injection² | 15.7 ± 0.9 | 15.8 ± 0.8 | 14.2 ± 1.1 | 16.6 ± 1.4 | 16.5 ± 0.8 | 15.6 ± 1.7 | — |
| Total Uptake Before | 12.3 ± 0.5^{c} | 15.3 ± 0.7^{a} | 13.1 ± 1.0^{bc} | 15.7 ± 1.1^{a} | 9.6 ± 1.0^{d} | 14.1 ± 2.2^{ab} | −0.2 ± 0.1^{e} |
| Cooking (%)³ | | | | | | | |
| Cook Yield (%)⁴ | 96.1 ± 1.9^{cd} | 102.0 ± 1.5^{ab} | 97.1 ± 0.7^{bc} | 105.8 ± 1.7^{a} | 91.1 ± 2.4^{de} | 90.5 ± 8.8^{e} | 86.6 ± 1.2^{e} |
| Cook Loss (%)⁵ | 14.4 ± 1.5^{b} | 11.6 ± 1.7^{ab} | 14.1 ± 1.2^{b} | 8.5 ± 0.7^{a} | 16.8 ± 2.6^{bc} | 20.6 ± 8.2^{c} | −13.2 ± 1.2^{ab} |
| Shear Force (N) | 5.3 ± 0.9^{bc} | 4.4 ± 1.0^{c} | 5.1 ± 2.3^{bc} | 4.4 ± 0.9^{c} | 8.2 ± 4.7^{a} | 4.2 ± 1.8^{c} | 7.4 ± 2.3^{ab} |

Samples were kept at 6° C. for 4.5 h in sealed bags after injection and before cooking. No Tumbling.
Means with different letter within a column are significantly different (p ≦ 0.1).
¹Protein source for the protein isolate was chicken.
²% Injection = (Weight after injection − green weight)/green weight * 100.
³Total uptake before cooking (%) = (Weight before booking − green weight)/green weight * 100.
⁴Cook Yield (%) = (Weight after cooking/green weight) * 100.
⁵Cook Loss (%) = (Weight before cooking − weight after cooking)/weight before cooking * 100.

Table 10 above shows that the buffer used had a moderate effect on cook yield and shear forces.

### EXAMPLE 12

### Comparison of Acid and Alkaline Processes

There are many similarities between the acid and the alkaline processes for producing muscle tissue having improved texture and/or water-holding capacity. Using either technique, the texture of the final protein food product can be changed, compared to the original, to as low as about 10% as tough as the same protein food product subject to the same heating conditions but absent the pH changes (i.e., very tender). The texture of the final protein food product can alternatively be made tougher (e.g., up to about 150% tougher) than the same protein food product subject to the same heating conditions, but absent the pH changes, with less water binding. Such may be desirable, e.g., with very soft types of fish (e.g., hake) to render a more solid cut of the fish.

There are, however, some significant differences between these two processes. Without being bound by a theory, as mentioned earlier, there is essentially only one side chain, the carboxylate group, of the muscle tissue protein which is involved with the solubilization process at acid pH. The carboxylate group is, however, generally in great abundance in the muscle proteins, typically contributing from about 22% to about 30% by number of the total amino acid side chains. The muscle proteins, however, include several groups that have pK's of increasing basicity on the alkaline side. Thus, whereas the acid process is a one-step process leading to substantially complete solubilization of muscle proteins, this is not the case with the alkaline process, where the changes in total net charge of the proteins occur step-wise. One of the two major changes occurs in the pH range of from about 6.5 to 7.5 (e.g., from about 6.6 to about 7.2), which is believed to be the result of the imidazole side chain of the histidine residues in the protein. Although these groups are not especially numerous, they appear to be important in the changes that occur in the solubility of the proteins. Over this pH range, in the presence of moderate salt concentrations, proteins which stabilize some of the muscle structures, particularly the thick filament and the Z-disk, are solubilized. The remaining muscle proteins of these structures are able to expand and imbibe water, in part depending on the repulsive forces brought about by the increasing net negative charge on these proteins as the pH is increased. By adding varying amounts of base, it is possible to modify the ability of the muscle protein food to imbibe water to different extents to give products of different characteristics. These products in turn can be re-adjusted, before or after cooking, to a lower pH (e.g., about 7.2, about 7.0, about 6.5, about 6.4, about 6.2, or about 6.0) to give a final product with a pH closer to the initial pH of the muscle tissue, but with improved properties.

### OTHER EMBODIMENTS

A number of embodiments of the invention have been described. Nevertheless, it will be understood that various modifications may be made without departing from the spirit and scope of the invention. For example, it is possible to utilize these processes over less than the entirety of the muscle food product to achieve a differential texture across the food product. For example, by spacing injections over a surface of the muscle food product (e.g., a cut of beef), solubilization of proteins can be achieved in a roughly checkerboard pattern. This can result in greater structural integrity in the final muscle food product, as compared with a muscle food product that had been treated in its entirety.

It is to be understood that while the invention has been described in conjunction with the detailed description thereof, the foregoing description is intended to illustrate and not limit the scope of the invention, which is defined by the scope of the appended claims. Other aspects, advantages, and modifications are within the scope of the following claims.

1. A method of preparing a food product, the method comprising:
obtaining a food product including at least one of a myofibrillar and a cytoskeletal protein and having a first pH;
adjusting the pH of the food product to a second pH that at least partially disorganizes at least a portion of the structure of the food product and;
heating the food product to a temperature above the denaturation temperature of the protein.

2. The method of claim 1, further comprising readjusting the pH of the food product to a third pH following heating the food product.

3. The method of claim 1, wherein the first pH of the food product is adjusted to a second pH by combining the food product with a pH-adjusting solution.

4. The method of claim 3, wherein the second pH is lower than the first pH.

5. The method of claim 4, wherein the pH-adjusting solution comprises an acid.

6. The method of claim 4, wherein the second pH is no more than about 5.5.

7. The method of claim 6, wherein the second pH is no more than about 4.0.

8. The method of claim 5, wherein the pH-adjusting solution comprises an acid selected from the group consisting of a weak acid, a strong acid, an organic acid, an inorganic acid, phosphoric acid, hydrochloric acid, sulfuric acid, sodium bisulfate, amino acids, and glycine.

9. The method of claim 8, wherein the pH-adjusting solution comprises an organic acid.

10. The method of claim 9, wherein the organic acid is selected from the group consisting of citric acid, malic acid, lactic acid, malonic acid, and succinic acid.

11. The method of claim 4, wherein the third pH is higher than the second pH.

12. The method of claim 3, wherein the second pH is higher than the first pH.

13. The method of claim 12, wherein the second pH is selected from the group consisting of no less than about 6.7.

14. The method of claim 12, wherein the third pH is lower than the second pH.

15. The method of claim 3, wherein the pH-adjusting solution comprises a base.

16. The method of claim 15, wherein the pH-adjusting solution comprises a buffer having a pKa above the second pH.

17. The method of claim 15, wherein the pH-adjusting solution comprises a buffer with a pH of about one pH unit above its pKa.

18. The method of claim 17, wherein the buffer comprises a compound selected from the group consisting of glycine, phosphate, and polyphosphate.

19. The method of claim 17, wherein the buffer comprises a compound selected from the group consisting of sodium acid pyrophosphate, sodium tripolyphosphate, bicarbonate, and amino acids.

20. The method of claim 17, wherein the pH-adjusting solution comprises a compound selected from the group consisting of sodium carbonate, sodium bicarbonate, a potassium salt, or amino acid.

21. The method of claim 2, wherein the third pH is approximately equal to the first pH.

22. The method of claim 2, wherein the third pH is higher than the first pH.

23. The method of claim 3, wherein the pH-adjusting solution comprises one or more texture-improving components.

24. The method of claim 23, wherein the one or more texture-improving components are selected from the group consisting of a protein isolate, calcium chloride, sodium chloride, and potassium salt.

25. The method of claim 24, wherein the one or more texture-improving components comprise a protein isolate prepared from one of muscle tissue, soy protein, or wheat protein.

26. The method of claim 24, wherein one or more texture-improving components comprise a protein isolate prepared from the same animal species as the food product.

27. The method of claim 1, wherein the food product comprises meat.

28. The method of claim 27, wherein the meat is selected from the group consisting of fish, shellfish, squid, poultry, beef, lamb, and pork.

29. The method of claim 1, wherein the food product is heated to a temperature selected from the group consisting of at least about 45° C., at least about 50° C., at least about 70° C., and at least about 80° C.

30. The method of claim 3, wherein the food product is combined with the pH-adjusting solution using a step selected from the group consisting of: injecting the pH-adjusting solution into the food product, tumbling the food product in the pH-adjusting solution, and soaking the food product in the pH-adjusting solution.

31. The method of claim 1, further comprising mincing the food product prior to combining the food product with the pH-adjusting solution.

32. A method of preparing a food product, the method comprising:
obtaining a food product including at least one of a myofibrillar and a cytoskeletal protein and having a first pH;
adjusting the pH of the food product to a second pH more basic than the first pH that at least partially disorganizes at least a portion of the structure of the food product; and
heating the food product to a temperature above the denaturation temperature of the protein.

33. The method of claim 32, further comprising between the adjusting step and the heating step readjusting the pH of the food product to a third pH.

34. The method of claim 32, wherein the second pH is no less than about 6.7.

35. A method of preparing a food product, the method comprising:
obtaining a food product including at least one of a myofibrillar and a cytoskeletal protein and having a first pH;
adjusting the pH of the food product to a second pH that at least partially disorganizes at least a portion of the structure of the food product by injecting the food product with a protein isolate.

36. The method of claim 35, wherein the protein isolate comprises a pH-adjusting solution.

37. The method of claim 35, wherein the second pH is higher than the first pH.

38. The method of claim 35, further comprising heating the food product to a temperature above the denaturation temperature of the protein.
